(19) United States
(12) Patent Application Publication
(10) Pub. No.: US 2026/0352767 A1
(43) Pub. Date: Nov. 5, 2026

(54) DOCUMENT CONVEYANCE APPARATUS, DOCUMENT READING APPARATUS, AND IMAGE FORMING APPARATUS

(71) Applicant: CANON KABUSHIKI KAISHA, Tokyo (JP)

(72) Inventor: MASAHITO IKEDA, Saitama (JP)

(21) Appl. No.: 19/639,494

(22) Filed: Apr. 6, 2026

(30) Foreign Application Priority Data
Apr. 30, 2025 (JP) 2025-075113

(51) Int. Cl. H04N 1/00; G03G 15/22

(52) U.S. Cl. CPC H04N 1/00615; G03G 15/228; H04N 1/00557; H04N 1/00602

(57) ABSTRACT

A document conveyance apparatus is provided. The apparatus includes a conveyance unit configured to convey the document supported on the document support unit so that the document passes through a reading unit. The conveyance unit includes first and second guide portions forming a conveyance path, a first roller configured to convey the document toward the curved portion, and a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

### BACKGROUND

### Field of the Technology

The present disclosure relates to a document conveyance apparatus that conveys a document, a document reading apparatus, and an image forming apparatus.

### Description of the Related Art

For example, in a document conveyance apparatus (so-called automatic document feeder (ADF)) that conveys a document to a reading unit that reads an image, a discharge tray that discharges the document is disposed below a document tray on which the document is set, and the document is conveyed so as to pass through a U-shaped conveyance path curved as viewed from a width direction. In such a curved conveyance path, there is a possibility that an upstream end of the document collides, and there has been proposed a conveyance path in which an elastic sheet-shaped member is disposed in order to suppress an impact of such a collision (see JP 2013-234074 A).

### SUMMARY

However, in the configuration of JP 2013-234074 A, there is a possibility that the elastic sheet-shaped member is peeled off and blocks the conveyance path, thereby causing a document jam. Therefore, it is desirable to improve conveyability of a document in the case of conveying the document on a curved conveyance path by another method.

According to a first aspect of the present disclosure, a document conveyance apparatus includes a document support unit configured to support a document, a conveyance unit configured to convey the document supported on the document support unit so that the document passes through a reading unit, and a discharge support unit provided below the document support unit in a vertical direction, at least partially overlapping the document support unit as viewed from above, and configured to support the document discharged from the conveyance unit. The conveyance unit includes a first guide portion forming a conveyance path including a curved portion curved as viewed from a width direction orthogonal to a conveyance direction of the document, and disposed on an outer side of the conveyance path at the curved portion, a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction, a first roller configured to convey the document toward the curved portion, and a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

According to a second aspect of the present disclosure, a document reading apparatus includes a document support unit configured to support a document, a reading unit configured to read an image of the document, a conveyance unit configured to convey the document supported on the document support unit so the document passes through the reading unit, and a discharge support unit provided below the document support unit in a vertical direction, at least partially overlapping the document support unit as viewed from above, and configured to support the document discharged from the conveyance unit. The conveyance unit includes a first guide portion forming a conveyance path including a curved portion curved as viewed from a width direction orthogonal to a conveyance direction of the document, and disposed on an outer side of the conveyance path at the curved portion, a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction, a first roller configured to convey the document toward the curved portion, and a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

According to a third aspect of the present disclosure, an image forming apparatus includes a document reading apparatus, and an image forming section configured to form an image on a sheet. The document reading apparatus includes a document support unit configured to support a document, a reading unit configured to read an image of the document, a conveyance unit configured to convey the document supported on the document support unit so the document passes through the reading unit, and a discharge support unit provided below the document support unit in a vertical direction, at least partially overlapping the document support unit as viewed from above, and configured to support the document discharged from the conveyance unit. The conveyance unit includes a first guide portion forming a conveyance path including a curved portion curved as viewed from a width direction orthogonal to a conveyance direction of the document, and disposed on an outer side of the conveyance path at the curved portion, a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction, a first roller configured to convey the document toward the curved portion, and a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

Features of the present disclosure will become apparent from the following description of embodiments with reference to the attached drawings. The following description of embodiments is described by way of example.

### BRIEF DESCRIPTION OF THE DRAWINGS

FIG. 1A is an overall schematic view illustrating a printer according to the present embodiment.

FIG. 1B is a schematic diagram illustrating an image forming engine.

FIG. 2 is a perspective view illustrating an inner guide of an automatic document feeder (ADF) according to the present embodiment.

FIG. 3 is an enlarged cross-sectional view illustrating a curved portion of a conveyance path of the ADF according to the present embodiment.

FIG. 4 is a top view illustrating the inner guide of the ADF according to the present embodiment.

FIG. 5 is a cross-sectional view illustrating a double-feed detection sensor of the ADF according to the present embodiment.

FIG. 6 is a graph illustrating a height position of a leading edge of a document with and without an idle roller according to the present embodiment.

### DESCRIPTION OF THE EMBODIMENTS

Hereinafter, the present embodiment will be described with reference to the drawings.

### Schematic Configuration of Image Forming Apparatus

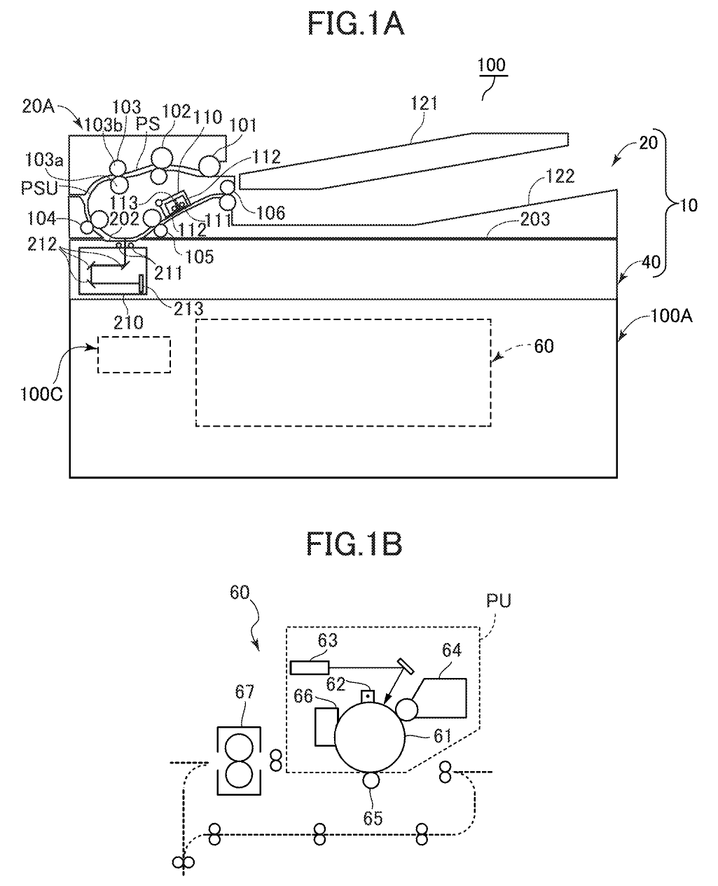

First, a schematic configuration of a printer 100 serving as an image forming apparatus according to the present embodiment will be described with reference to FIGS. 1A and 1B. FIG. 1A is an overall schematic view illustrating the printer according to the present embodiment. FIG. 1B is a schematic diagram illustrating an image forming engine.

The printer 100 according to the present embodiment is an electrophotographic laser beam printer. As illustrated in FIG. 1A, the printer 100 includes a printer main body 100A and an image reading apparatus 10 serving as a document reading apparatus mounted on an upper portion of the printer main body 100A. In the following description, a sheet includes, in addition to plain paper, special paper such as thick paper and coated paper, a recording material having a special shape such as an envelope and index paper, and a plastic film or cloth for an overhead projector, and a document is an example of the sheet.

The printer main body 100A includes an image forming engine 60 serving as an image forming section therein. As illustrated in FIG. 1B, the image forming engine 60 includes an image forming unit PU serving as an electrophotographic image forming unit, and a fixing device 67. When an instruction to start an image forming operation is issued, a photosensitive drum 61 serving as a photosensitive member rotates, and a surface of the photosensitive drum 61 is uniformly charged by a charging device 62. Then, an exposure device 63 modulates and outputs a laser beam based on image data transmitted from the image reading apparatus 10 serving as an image reading unit or an external computer, and scans the surface of the photosensitive drum 61 to form an electrostatic latent image. The electrostatic latent image is visualized (developed) by a toner supplied from a developing device 64 to become a toner image.

In parallel with such an image forming operation, a feeding operation of feeding the sheet supported on a cassette or a manual feeding tray (not shown) toward the image forming engine 60 is performed. The fed sheet is conveyed in accordance with the progress of the image forming operation by the image forming unit PU. Then, the toner image borne on the photosensitive drum 61 is transferred to the sheet by a transfer roller 65. The toner remaining on the photosensitive drum 61 after transferring the toner image is collected by a cleaning device 66. The sheet to which the unfixed toner image has been transferred is delivered to the fixing device 67, nipped by a roller pair, and heated and pressurized. The sheet on which an image is fixed by melting and fixing of the toner is discharged by a discharge unit such as a discharge roller pair.

### Image Reading Apparatus

Next, the image reading apparatus 10 will be described in detail. As illustrated in FIG. 1A, the image reading apparatus 10 includes a document conveyance apparatus (hereinafter, referred to as an automatic document feeder “ADF”) 20 that automatically conveys the document supported on a document tray 121, and an image reading unit 40 that reads the document conveyed by the ADF 20. That is, the ADF 20 conveys the sheet serving as the document to the image reading unit 40, and the image reading unit 40 includes a front side reading unit 210 serving as a reading unit that reads an image on a front side of the document conveyed by the ADF 20. The ADF 20 is rotatably supported with respect to the image reading unit 40 by a hinge mechanism (not shown) so that a feeding-reading glass 202 and a platen glass 203 serving as light transmissive members that transmit light can be opened.

The ADF 20 includes a document tray 121 serving as a document support unit that supports the document, an ADF main body 20A serving as a conveyance unit that conveys the document supported on the document tray 121, and a discharge tray 122 serving as a discharge support unit that supports the document discharged from the ADF main body 20A. That is, the ADF main body 20A conveys the document supported on the document tray 121 so that the document passes through a reading position of the front side reading unit 210. Further, the discharge tray 122 is disposed so as to at least partially overlap the document tray 121 when viewed from an up-down direction (vertical direction), that is, disposed below the document tray 121.

The ADF main body 20A includes a conveyance path PS communicating from the document tray 121 to the discharge tray 122, and the conveyance path PS includes a curved portion PSU and is formed in a U shape as a whole when viewed from a width direction orthogonal to a document conveyance direction. Since the conveyance path is formed in a U shape in this manner, in a case where a user sets a plurality of documents on the document tray 121, the set documents can be discharged to the discharge tray 122 in the same page order. In addition, by disposing the discharge tray 122 below the document tray 121, the ADF 20 can be downsized.

In the ADF main body 20A, a pickup roller 101, a separation roller pair 102, a pull-out roller pair 103, a pre-reading roller pair 104 serving as a conveyance roller pair, a post-reading roller pair 105, and a discharge roller pair 106 are disposed along the conveyance path PS. The pull-out roller pair 103 includes a driving roller 103a serving as a first roller driven by a motor (not shown) and a driven roller 103b serving as a second roller that rotates following the driving roller 103a.

The ADF 20 also includes a back side reading unit 110 serving as a reading unit for reading an image on a back side of the document. The back side reading unit 110 includes a reading glass 112, an illumination 111 that irradiates the document with light via the reading glass 112, and a reading sensor 113 that reads the image based on light reflected from the document. Although the back side reading unit 110 is described as being implemented by a so-called contact image sensor (CIS), the back side reading unit 110 is not limited thereto, and any configuration may be used as long as the image can be read.

Meanwhile, the image reading unit 40 includes the feeding-reading glass 202, the platen glass 203, and the front side reading unit 210 for reading the front side of the document. The front side reading unit 210 includes an illumination 211 that irradiates the document with light through the feeding-reading glass 202, a plurality of mirrors 212 that reflects and guides light reflected from the document, and a reading sensor 213 that reads the image based on the reflected light. The configuration of the front side reading unit 210 is not limited to the configuration of the present embodiment, and any configuration may be used as long as the image can be read.

The image reading apparatus 10 can read the image from the document by a feeding-reading mode in which a document image is scanned while the document supported on the document tray 121 is fed by the ADF 20 and a fixed-reading mode in which the document supported on the platen glass 203 is scanned. The feeding-reading mode is selected in a case where a document sensor (not shown) detects the document supported on the document tray 121, or in a case where the user explicitly instructs the feeding-reading mode by using an operation panel or the like of the printer main body 100A.

When the feeding-reading mode is executed, the uppermost document set on the document tray 121 is fed by the pickup roller 101, and the documents are separated sheet by sheet at a separation nip of the separation roller pair 102. Thereafter, the document is conveyed by the pre-reading roller pair 104 so as to pass over a front surface of the feeding-reading glass 202, and then conveyed so as to pass over the reading glass 112 of the back side reading unit 110.

The image on the front side of the document is read by the front side reading unit 210 through the feeding-reading glass 202, and the image on the back side of the document is read by the back side reading unit 110. Image information photoelectrically converted by light receiving elements of the reading sensor 213 of the front side reading unit 210 and the reading sensor 113 of the back side reading unit 110 is transferred to a control unit 100C (see FIG. 1A). Then, the document having passed through the reading glass 112 is discharged to the discharge tray 122 by the discharge roller pair 106.

On the other hand, the fixed-reading mode is selected in a case where the apparatus detects the document supported on the platen glass 203 or in a case where the user explicitly instructs the fixed-reading mode by using the operation panel or the like of the printer main body 100A. In this case, the document on the platen glass 203 does not move, and the front side reading unit 210 moves along the platen glass 203 to scan the document. Similarly, the image information photoelectrically converted by the light receiving element of the reading sensor 213 of the front side reading unit 210 is transferred to the control unit 100C (see FIG. 1A).

### Configuration on Periphery of Curved Portion

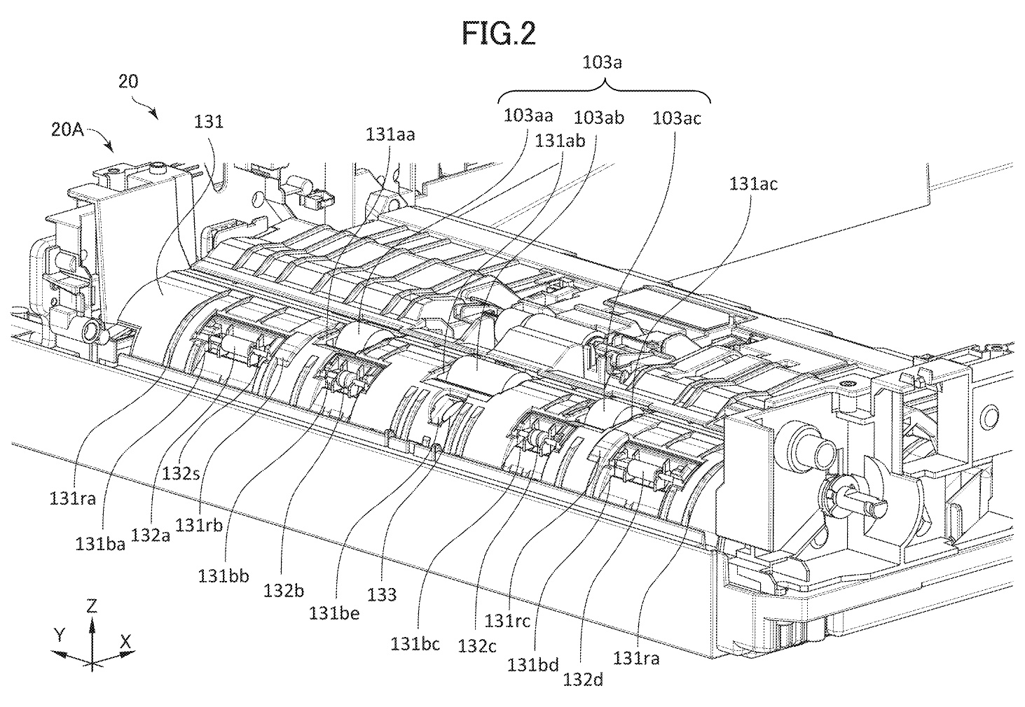

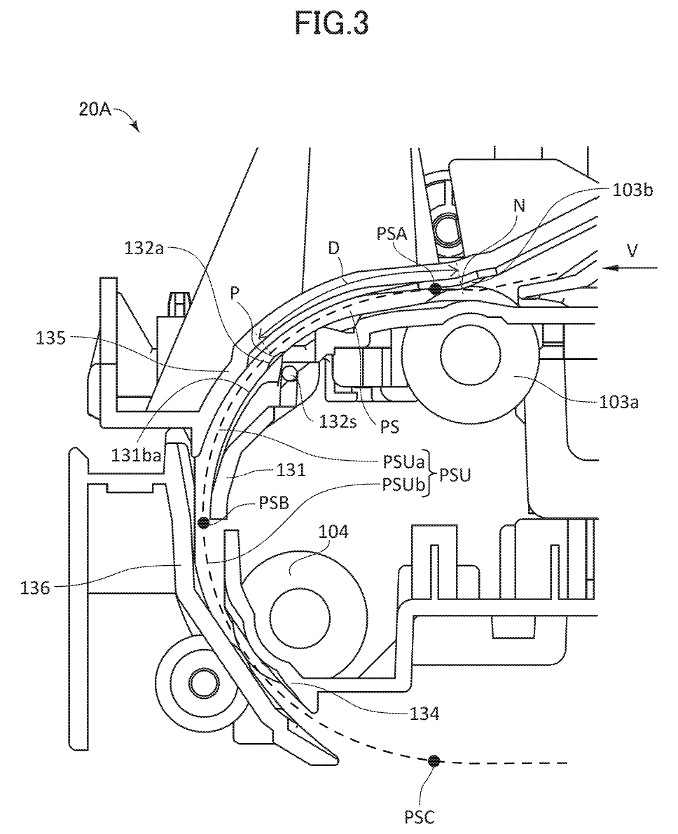

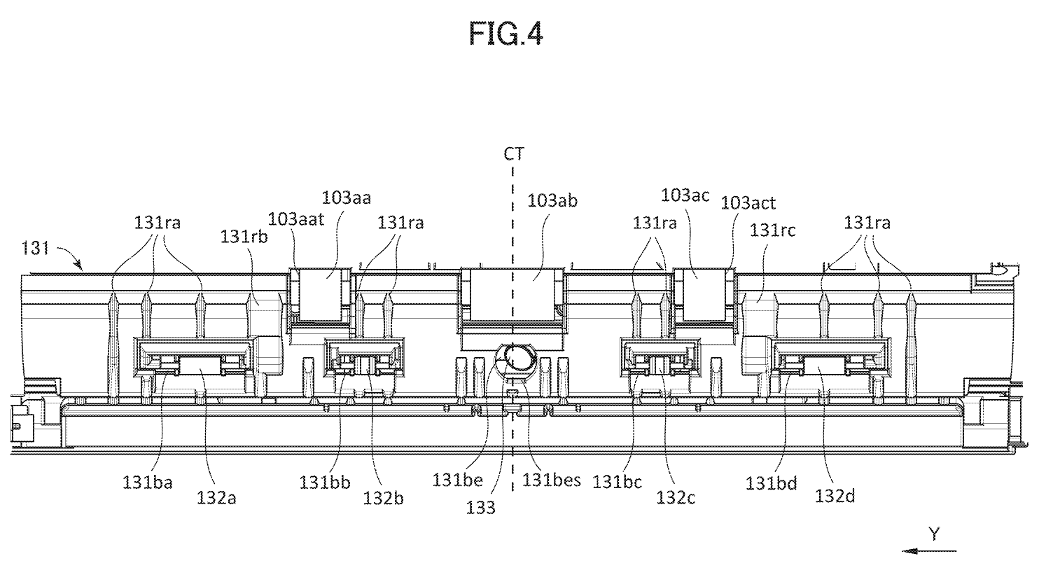

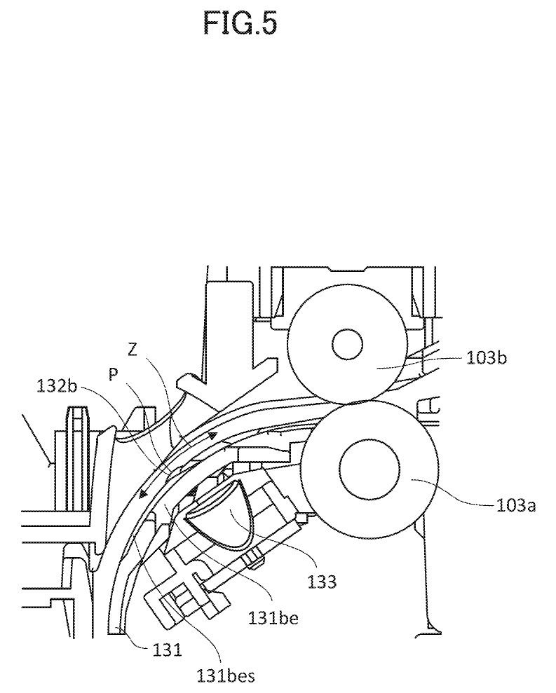

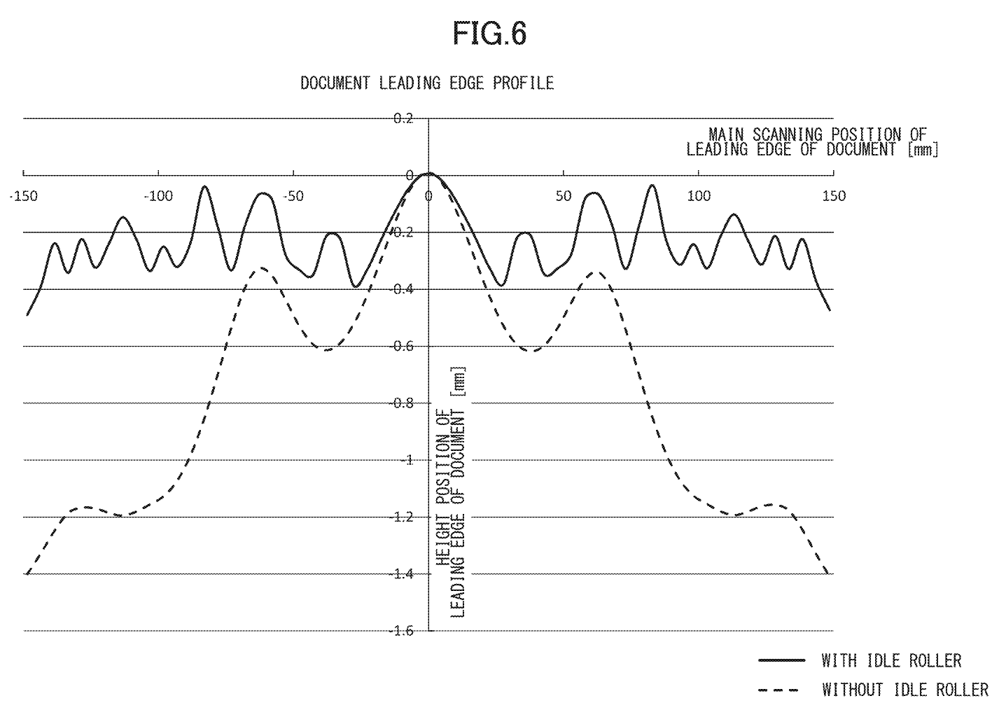

Next, a configuration on the periphery of the curved portion PSU of the conveyance path PS in the ADF 20 according to the present embodiment will be described with reference to FIGS. 2-6. FIG. 2 is a perspective view illustrating an inner guide of the ADF according to the present embodiment. FIG. 3 is an enlarged cross-sectional view illustrating the curved portion of the conveyance path of the ADF according to the present embodiment. FIG. 4 is a top view illustrating the inner guide of the ADF according to the present embodiment. FIG. 5 is a cross-sectional view illustrating a double-feed detection sensor of the ADF according to the present embodiment. FIG. 6 is a graph illustrating a height position of a leading edge of the document with and without an idle roller according to the present embodiment. FIG. 2 illustrates the ADF 20 in a state in which an upper outer guide 135 (see FIG. 3) is removed to expose an upper inner guide 131. FIG. 2 illustrates a state in which the ADF 20 is closed with respect to the image reading unit 40, and three-dimensional directions of the printer 100 and the ADF 20 are referred to as a left-right direction X, a width direction Y, and an up-down direction Z. The width direction Y is a direction orthogonal to a conveyance direction V, and is also a front-rear direction. In general, the front direction of the printer 100 refers to the direction in which the operation panel (not shown) is oriented.

For example, in the conveyance path including the curved portion curved in a U shape when viewed from the width direction, when the document is conveyed, the leading edge of the document may collide with an outer guide and generate noise. In addition, when the document slides on the outer guide, a conveyance speed of the document changes, which may affect image reading accuracy (geometric characteristics of image reading quality, deterioration of color shift, and the like). Therefore, in the present embodiment, a configuration on the periphery of the curved portion described below improves conveyability of the document when the document is conveyed along the curved portion.

As illustrated in FIG. 3, the ADF main body 20A includes the curved portion PSU in the conveyance path PS for conveying the document, and the conveyance path PS is implemented by a so-called U-turn path. Further, the curved portion PSU includes an upper curved portion PSUa from an upstream end PSA where a curvature starts in the document conveyance direction V to a turnaround point PSB where the curvature is reversed, and a lower curved portion PSUb from the turnaround point PSB to a downstream end PSC where the curvature ends. That is, when a portion from the upstream end PSA to the downstream end PSC of the curved portion PSU is defined as an arc from 0 degrees to 180 degrees, the upper curved portion PSUa ranges from approximately 0 degrees to 90 degrees, and the lower curved portion PSUb ranges from approximately 90 degrees to 180 degrees.

Further, the curved portion PSU in the conveyance path PS is formed by the upper outer guide 135 and a lower outer guide 136 serving as first guide portions, and the upper inner guide 131 and a lower inner guide 134 serving as second guide portions disposed to face the upper outer guide 135 and the lower outer guide 136. That is, the upper inner guide 131 and the lower inner guide 134 are disposed on an inner side of the conveyance path PS. Further, roughly, the upper curved portion PSUa is formed by the upper outer guide 135 and the upper inner guide 131, and the lower curved portion PSUb is formed by the lower outer guide 136 and the lower inner guide 134. The upper outer guide 135, the lower outer guide 136, the upper inner guide 131, and the lower inner guide 134 are supported by a frame (not shown) of the ADF main body 20A. When a document jam or the like occurs in the curved portion PSU in the conveyance path PS, the conveyance path PS is opened by opening the upper outer guide 135, and the jammed document can be removed.

As illustrated in FIGS. 2 and 3, in the upper inner guide 131, upstream holes 131aa, 131ab, and 131ac are formed therethrough in the vicinity of the upstream end PSA of the curved portion PSU side by side in the width direction Y orthogonal to the conveyance direction V. The driving roller 103a of the pull-out roller pair 103 protrudes from each of the upstream holes 131aa, 131ab, and 131ac to the conveyance path PS. Specifically, the driving roller 103a of the pull-out roller pair 103 includes a corresponding one of roller portions 103aa, 103ab, and 103ac arranged side by side on a rotation shaft (not shown), and each of the roller portions 103aa, 103ab, and 103ac is disposed so as to protrude from a corresponding one of the upstream holes 131aa, 131ab, and 131ac to the conveyance path PS. The roller portions 103aa and 103ac (upstream holes 131aa and 131ac) are disposed at positions outward of the roller portion 103ab (upstream hole 131ab) in the width direction, and are formed to have a shorter length in the width direction than the roller portion 103ab.

In the upper inner guide 131, downstream holes 131ba, 131bb, 131be, 131bc, and 131bd are formed side by side in the width direction Y at positions downstream of the driving roller 103a in the conveyance direction V. That is, the downstream holes 131ba, 131bb, 131be, 131bc, and 131bd are arranged side by side in the width direction Y at the positions downstream of the upstream holes 131aa, 131ab, and 131ac arranged side by side in the width direction Y as described above. In the downstream holes 131ba, 131bb, 131bc, and 131bd, idle rollers 132a, 132b, 132c, and 132d that rotate following the document conveyed by the driving roller 103a are rotatably supported and disposed. That is, the idle rollers 132a, 132b, 132c, and 132d are disposed at the upper curved portion PSUa of the conveyance path PS and are disposed to face the upper outer guide 135. The idle rollers 132a, 132b, 132c, and 132d are rotatably supported on side walls of the downstream holes 131ba, 131bb, 131bc, and 131bd by shafts 132s, respectively.

As illustrated in FIG. 3, the idle rollers 132a, 132b, 132c, and 132d are disposed such that an apex P protrudes to the conveyance path PS. The apex P is positioned at a distance D in the conveyance direction V downstream from a nip N formed by the driving roller 103a and the driven roller 103b of the pull-out roller pair 103 abutting on each other. In a case where the distance D is in a range of 20 mm to 40 mm, an effect of reducing a conveyance resistance against the document is significant, and an effect of suppressing waviness of the sheet described in detail below is significant.

Among the idle rollers 132a, 132b, 132c, and 132d, the idle rollers 132a and 132d are disposed at positions outward of the idle rollers 132b and 132c in the width direction Y as illustrated in FIG. 4. That is, with respect to a conveyance center CT, the idle rollers 132a are disposed at a position outward of an outer end portion 103aat (first outer end portion) of the roller portion 103aa that is positioned on an outer side in the width direction Y and the idle rollers 132d is disposed at a position outward of an outer end portion 103act (second outer end portion) of the roller portion 103ac.

That is, in the present embodiment, the idle roller 132a forms a first rotary member or a first idle roller. The idle roller 132a is disposed so as to protrude upward from the upper inner guide 131. The idle roller 132a is disposed downstream of the roller portion 103aa in the conveyance direction V at a position outward of the outer end portion 103aat of the roller portion 103aa in the width direction Y. In the present embodiment, the idle roller 132d forms a second rotary member or a second idle roller. The idle roller 132d is disposed so as to protrude upward from the upper inner guide 131. The idle roller 132d is disposed downstream of the roller portion 103ac in the conveyance direction V at a position outward of the outer end portion 103act of the roller portion 103ac that is opposite to the idle roller 132a in the width direction Y, and is disposed on a side of the roller portion 103ac that is opposite to the idle roller 132a.

The idle rollers 132b and 132c each form a third rotary member or a third idle roller. The idle rollers 132b and 132c are disposed at positions inward (on the side of the conveyance center CT) of the outer end portion 103aat of the roller portion 103aa and the outer end portion 103act of the roller portion 103ac, respectively. Specifically, the idle roller 132b is disposed between the roller portion 103aa and the roller portion 103ab in the width direction, and the idle roller 132c is disposed between the roller portion 103ab and the roller portion 103ac in the width direction.

Meanwhile, on the upper inner guide 131, a plurality of standard conveyance ribs 131ra serving as first ribs that come into contact with and guide the document at outer edge portions thereof are formed to be provided upright. The plurality of standard conveyance ribs 131ra are arranged at intervals in a range in which the document may pass in the width direction Y based on the conveyance center CT. On the upper inner guide 131, a conveyance rib 131rb serving as a second rib and a conveyance rib 131rc serving as a third rib are formed to be provided upright. Each of the conveyance ribs 131rb and 131rc has an outer edge portion (outer plane) whose width is larger than that of the standard conveyance rib 131ra in the width direction Y, comes into contact with and guide the document at the outer edge portion. The conveyance ribs 131rb and 131rc are arranged side by side so as to be adjacent to inner sides of the idle rollers 132a and 132d disposed on the outer sides in the width direction Y as described above. That is, the conveyance rib 131rb is disposed between the idle roller 132a and the idle roller 132b in the width direction Y, and the conveyance rib 131rc is disposed between the idle roller 132c and the idle roller 132d in the width direction Y. The document conveyed on the conveyance path PS is substantially conveyed in a manner in which a virtual plane connecting outer edges of the plurality of standard conveyance ribs 131ra and the conveyance ribs 131rb and 131rc on the upper inner guide 131 is used as a guide surface.

As illustrated in FIGS. 4 and 5, a double-feed detection sensor 133 serving as a sensor is disposed in the downstream hole 131be serving as a hole positioned at the center (on the conveyance center CT) in the width direction Y among the plurality of downstream holes described above. That is, the double-feed detection sensor 133 is arranged so as to be aligned with the idle rollers 132a, 132b, 132c, and 132d in the width direction Y.

Specifically, the double-feed detection sensor 133 is implemented by, for example, an ultrasonic sensor or the like, is disposed at a position inward of the downstream hole 131be, and is capable of emitting an ultrasonic wave from the downstream hole 131be toward the conveyance path PS. For example, the double-feed detection sensor 133 detects a reflected ultrasonic wave and detects whether the number of documents is one or two or more according to the degree of attenuation. For example, in the ADF 20, a phenomenon called double feeding in which overlapping documents are conveyed without being separated due to unexpected circumstances (for example, mixing of an adhesive material) or the like occurs very rarely. When the double-feed detection sensor 133 detects overlapping of the documents, a control unit (not shown) receives a detection signal and stops conveying the documents at that time. As a result, it is possible to prevent missing of the acquired image data (scan data) of the document and damage of the document caused by unexpected conveyance.

Meanwhile, in the ADF 20, since the document to be conveyed is not a new paper sheet but is brought in by the user, it is assumed that the document is folded or damaged. When such a document is conveyed, for example, it is conceivable that the leading edge of the document is bent and is caught by an end portion of the downstream hole 131be described above. When such a catch occurs at the leading edge of the document, there is a possibility that noise is generated or the image reading accuracy is affected by a change in the conveyance speed, similarly to when the leading edge of the document is wavy.

Therefore, in the present embodiment, the double-feed detection sensor 133 is disposed so as to be housed in the downstream hole 131be, and in addition, a guide surface 131bes is formed at the end portion (downstream portion) of the downstream hole 131be in the conveyance direction V. Furthermore, in the present embodiment, the apexes P of the idle rollers 132a, 132b, 132c, and 132d described above are disposed within a range of a length Z of the downstream hole 131be in the conveyance direction V (within a projection region as viewed in the width direction). With such a structure, the apex P protrudes from the guide surface (a virtual plane connecting the outer edges of the standard conveyance ribs 131ra and the conveyance ribs 131rb and 131rc) of the upper inner guide 131. Therefore, it is possible to reduce a risk of occurrence of a catch of the document at the end portion of the downstream hole 131be. In the present embodiment, the double-feed detection sensor 133 is disposed in the downstream hole 131be, but the present technology is not limited thereto, and the same effect regarding the conveyability of the document can be obtained regardless of the type of the sensor.

### Reduction of Waviness of Leading Edge of Document in Present Embodiment

Next, an effect of reducing waviness at the leading edge of the document conveyed by the pull-out roller pair 103 using the idle rollers 132a, 132b, 132c, and 132d will be described with reference to FIG. 6. In FIG. 6, a shape of the leading edge (document leading edge profile) when the document is conveyed is simulated by a computer as a state before the leading edge of the document passes through the pull-out roller pair 103 and comes into contact with the upper outer guide 135. A horizontal axis represents a position of the leading edge of the document in the width direction, and a vertical axis represents a position of the leading edge of the document in the up-down direction, which may be considered to be substantially synonymous with how the leading edge of the document is wavy. In FIG. 6, positions of the roller portions 103aa, 103ab, and 103ac are positions of -65, 0, and 65 mm on the horizontal axis, respectively.

In FIG. 6, a broken line indicates a height position at the leading edge of the document (document leading edge profile) in the up-down direction in a case where the idle rollers 132a, 132b, 132c, and 132d are not disposed. Further, a solid line indicates a height position at the leading edge of the document (document leading edge profile) in the up-down direction in a case where the idle rollers 132a, 132b, 132c, and 132d are disposed.

For example, in a case where no idle roller is disposed, when the document is conveyed to a position downstream of the nip N of the pull-out roller pair 103, the waviness as indicated by the broken line in FIG. 6 occurs at the leading edge of the document as viewed from the conveyance direction V. The wavy shape enhances stiffness (that is, straightness) of the document in the conveyance direction V. However, at the curved portion PSU of the conveyance path PS, the curved shape inevitably causes the document to be conveyed by bending the leading edge of the document so as to bend a portion of the document with the enhanced stiffness. At this time, since the document is deformed so as to forcibly bend the wavy shape, behavior of the document becomes unstable. As the most prominent example of the unstable behavior, generation of wrinkles in a direction parallel to the conveyance direction V in the document can be cited. If the document reaches the pre-reading roller pair 104 in the midway of the curved portion PSU in such an unstable state, the instability is taken over also in the subsequent conveyance, a skew feeding tendency appears in the conveyance of the document, and quality of the obtained read image may be adversely affected. Therefore, in order to prevent such a problem, it is effective to suppress the waviness of the leading edge of the document at the curved portion PSU, which is the cause of the problem.

As described above, the ADF 20 according to the present embodiment includes the idle rollers 132a, 132b, 132c, and 132d provided at positions downstream of the pull-out roller pair 103 in the conveyance direction V. Therefore, when the document is conveyed to a position downstream of the nip N of the pull-out roller pair 103, the leading edge of the document has a wavy shape close to a linear shape as indicated by the solid line in FIG. 6 when viewed from the conveyance direction V. In particular, since the idle rollers 132a and 132d are disposed at positions outward of the roller portions 103aa and 103ac of the pull-out roller pair 103 in the width direction Y, outer sides of the leading edge of the document in the width direction are supported from below, so that sagging of the outer sides of the leading edge of the document hardly occurs. Therefore, an effect of spreading the document in the width direction Y at a position near an entrance of the curved portion PSU is obtained, and the waviness at the leading edge of the document is reduced. As a result, the above-described problem is suppressed, that is, the current conveyability in the case of conveying the document at the curved portion PSU can be improved, and degradation of the quality of the obtained read image can also be prevented.

Further, in the present embodiment, the idle rollers 132a and 132d disposed at positions outward of the idle rollers 132b and 132c present within a width range between the roller portions 103aa and 103ac of the pull-out roller pair 103 in the width direction Y are implemented by wider idle rollers having a larger length in the width direction Y than that of the idle rollers 132b and 132c. As a result, for example, even in the case of a wide document having a large size in the width direction, it is possible to suppress the waviness at the leading edge of the document.

Further, the conveyance ribs 131rb and 131rc disposed at positions outward of the roller portions 103aa and 103ac and inward of the idle rollers 132a and 132d in the width direction Y are formed to have a wide shape having a width larger than that of the standard conveyance rib 131ra in the width direction Y. As a result, it is possible to suppress the waviness due to sagging of the document between the roller portions 103aa and 103ac of the pull-out roller pair 103 and the idle rollers 132a and 132d, and it is possible to obtain an effect of further suppressing the waviness at the leading edge of the document.

### Possibility of Other Embodiments

In the present embodiment described above, the idle rollers 132a and 132d are disposed at positions outward of the roller portions 103aa and 103ac in the width direction, respectively. However, the present technology is not limited thereto, and even with a configuration in which only one of the idle rollers 132a and 132d is disposed, it is possible to obtain an effect of suppressing the waviness at the leading edge of the document.

Furthermore, in the present embodiment, the idle rollers 132a, 132b, 132c, and 132d have been described as an example of the rotary members disposed downstream of the pull-out roller pair 103 in the conveyance direction V. However, the present technology is not limited thereto, and the rotary member may be, for example, a belt or a ball (sphere) that rotates following rotation of another member, that is, the rotary member may be any member as long as the member is rotatable following rotation of another member.

In addition, in the present embodiment, the idle rollers 132b and 132c have been described to have smaller widths than the idle rollers 132a and 132d, but the present technology is not limited thereto, and the idle rollers 132b and 132c may have the same widths as the idle rollers 132a and 132d or may have larger widths than the idle rollers 132a and 132d.

In the present embodiment, the conveyance ribs 131rb and 131rc are formed in a wide shape having a larger width in the width direction Y than the standard conveyance rib 131ra. However, the present technology is not limited thereto, and the conveyance ribs 131rb and 131rc may have the same width as the standard conveyance rib. In this case, for example, the number of conveyance ribs disposed between the roller portions 103aa, 103ab, and 103ac or between the idle rollers 132a, 132b, 132c, and 132d may be increased.

In the present embodiment, the standard conveyance ribs 131ra and the conveyance ribs 131rb and 131rc are arranged (in parallel) in the conveyance direction V. However, the present technology is not limited thereto, and the standard conveyance ribs 131ra and the conveyance ribs 131rb and 131rc may be arranged to be inclined so as to spread or narrow relative to the conveyance center CT as extending downstream in the conveyance direction V.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-075113, filed Apr. 30, 2025 which is hereby incorporated by reference herein in its entirety.

What is claimed is:

1. A document conveyance apparatus comprising:
a document support unit configured to support a document;
a conveyance unit configured to convey the document supported on the document support unit so that the document passes through a reading unit; and
a discharge support unit provided below the document support unit in a vertical direction, at least partially overlapping the document support unit as viewed from above, and configured to support the document discharged from the conveyance unit,
wherein the conveyance unit includes:
a first guide portion forming a conveyance path including a curved portion curved as viewed from a width direction orthogonal to a conveyance direction of the document, and disposed on an outer side of the conveyance path at the curved portion;
a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction;
a first roller configured to convey the document toward the curved portion; and
a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

2. The document conveyance apparatus according to claim 1, further comprising a second rotary member disposed so as to protrude upward from the second guide portion, disposed downstream of the first roller in the conveyance direction at a position outward of a second outer end portion of the first roller on a side opposite to the first rotary member in the width direction with respect to the conveyance center, and configured to rotate following the document conveyed by the first roller.

3. The document conveyance apparatus according to claim 2, wherein
the first rotary member is a first idle roller, and
the second rotary member is a second idle roller.

4. The document conveyance apparatus according to claim 3, further comprising a second roller configured to abut on the first roller to form a nip,
wherein an apex of each of the first idle roller and the second idle roller is disposed within a range of 20 mm to 40 mm downstream from the nip in the conveyance direction.

5. The document conveyance apparatus according to claim 3, further comprising one or more third idle rollers arranged so as to be aligned with the first idle roller and the second idle roller at positions inward of the first idle roller and the second idle roller in the width direction,
wherein the first idle roller and the second idle roller have a width larger than a width of each of the one or more third idle rollers in the width direction.

6. The document conveyance apparatus according to claim 3, wherein
the second guide portion includes a plurality of downstream holes arranged side by side in the width direction at positions downstream of the first roller in the conveyance direction, and
each of the first idle roller and the second idle roller is disposed in a corresponding one of the plurality of downstream holes and is disposed such that an apex of each of the first idle roller and the second idle roller protrudes from the second guide portion.

7. The document conveyance apparatus according to claim 3, further comprising:
a first rib formed on the second guide portion and configured to guide the document at an outer edge portion thereof; and
a plurality of second ribs disposed on inner sides of the first rotary member and the second rotary member in the width direction so as to be aligned with the first rotary member and the second rotary member, formed on the second guide portion such that each outer edge portion of the second ribs has a width larger than a width of the first rib in the width direction, and configured to guide the document at the outer edge portion.

8. The document conveyance apparatus according to claim 7, further comprising two third rotary members arranged so as to be aligned with the first rotary member and the second rotary member at positions inward of the first rotary member and the second rotary member in the width direction, wherein
the second ribs are disposed between the first rotary member and one of the two third rotary members so as to be aligned with the first rotary member and the one third rotary member in the width direction, and
the document conveyance apparatus further comprises a third rib disposed between the second rotary member and the other of the two third rotary members so as to be aligned with the second rotary member and the other third rotary member in the width direction, formed on the second guide portion such that an outer edge portion of the third rib has a width larger than a width of the first rib in the width direction, and configured to guide the document at the outer edge portion.

9. The document conveyance apparatus according to claim 2, wherein
the second guide portion includes a hole disposed at a position inward of the first rotary member and the second rotary member in the width direction so as to be aligned with the first rotary member and the second rotary member, and
the document conveyance apparatus further comprises a sensor disposed in the hole and configured to detect double feeding of the documents.

10. A document reading apparatus comprising:
a document support unit configured to support a document;
a reading unit configured to read an image of the document;
a conveyance unit configured to convey the document supported on the document support unit so the document passes through the reading unit; and
a discharge support unit provided below the document support unit in a vertical direction, at least partially overlapping the document support unit as viewed from above, and configured to support the document discharged from the conveyance unit,
wherein the conveyance unit includes:
a first guide portion forming a conveyance path including a curved portion curved as viewed from a width direction orthogonal to a conveyance direction of the document, and disposed on an outer side of the conveyance path at the curved portion;
a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction;
a first roller configured to convey the document toward the curved portion; and
a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center, and configured to rotate following the document conveyed by the first roller.

11. The document reading apparatus according to claim 10, further comprising a second rotary member disposed so as to protrude upward from the second guide portion, disposed downstream of the first roller in the conveyance direction at a position outward of a second outer end portion of the first roller on a side opposite to the first rotary member in the width direction with respect to the conveyance center, and configured to rotate following the document conveyed by the first roller.

12. The document reading apparatus according to claim 11, wherein
the first rotary member is a first idle roller, and
the second rotary member is a second idle roller.

13. The document reading apparatus according to claim 12, further comprising a second roller configured to abut on the first roller to form a nip,
wherein an apex of each of the first idle roller and the second idle roller is disposed within a range of 20 mm to 40 mm downstream from the nip in the conveyance direction.

14. The document reading apparatus according to claim 12, further comprising one or more third idle rollers arranged so as to be aligned with the first idle roller and the second idle roller at positions inward of the first idle roller and the second idle roller in the width direction, and
wherein the first idle roller and the second idle roller have a width larger than a width of each of the one or more third idle rollers in the width direction.

15. The document reading apparatus according to claim 12, wherein
the second guide portion includes a plurality of downstream holes arranged side by side in the width direction at positions downstream of the first roller in the conveyance direction, and
each of the first idle roller and the second idle roller is disposed in a corresponding one of the plurality of downstream holes and is disposed such that an apex of each of the first idle roller and the second idle roller protrudes from the second guide portion.

16. The document reading apparatus according to claim 12, further comprising:
a first rib formed on the second guide portion and configured to guide the document at an outer edge portion thereof; and
a plurality of second ribs disposed on inner sides of the first rotary member and the second rotary member in the width direction so as to be aligned with the first rotary member and the second rotary member, formed on the second guide portion such that each outer edge portion of the second ribs has a width larger than a width of the first rib in the width direction, and configured to guide the document at the outer edge portion.

17. The document reading apparatus according to claim 16, further comprising two third rotary members arranged so as to be aligned with the first rotary member and the second rotary member at positions inward of the first rotary member and the second rotary member in the width direction, wherein
the second ribs are disposed between the first rotary member and one of the two third rotary members so as to be aligned with the first rotary member and the one third rotary member in the width direction, and
the document reading apparatus further comprises a third rib disposed between the second rotary member and the other of the two third rotary members so as to be aligned with the second rotary member and the other third rotary member in the width direction, formed on the second guide portion such that an outer edge portion of the third rib has a width larger than a width of the first rib in the width direction, and configured to guide the document at the outer edge portion.

18. The document reading apparatus according to claim 11, wherein
the second guide portion includes a hole disposed at a position inward of the first rotary member and the second rotary member in the width direction so as to be aligned with the first rotary member and the second rotary member, and
the document reading apparatus further comprises a sensor disposed in the hole and configured to detect double feeding of the documents.

19. The document reading apparatus according to claim 11, further comprising a conveyance roller pair disposed upstream of the reading unit in the conveyance direction and configured to convey the document toward the reading unit,
wherein the first rotary member is disposed upstream of the conveyance roller pair in the conveyance direction.

20. An image forming apparatus comprising:
a document reading apparatus; and
an image forming section configured to form an image on a sheet, wherein
the document reading apparatus includes:
a document support unit configured to support a document;
a reading unit configured to read an image of the document;
a conveyance unit configured to convey the document supported on the document support unit so the document passes through the reading unit; and
a discharge support unit provided below the document support unit in a vertical direction, at least partially overlapping the document support unit as viewed from above, and configured to support the document discharged from the conveyance unit,
wherein the conveyance unit includes:
a first guide portion forming a conveyance path including a curved portion curved as viewed from a width direction orthogonal to a conveyance direction of the document, and disposed on an outer side of the conveyance path at the curved portion;
a second guide portion disposed to face the first guide portion to form the conveyance path with the first guide portion, disposed on an inner side of the conveyance path at the curved portion, and positioned below the first guide portion in the vertical direction in a region upstream of the curved portion in the conveyance direction;
a first roller configured to convey the document toward the curved portion; and
a first rotary member provided in the region upstream of the curved portion, disposed so as to protrude upward in the vertical direction from the second guide portion, disposed downstream of the first roller in the conveyance direction at a position outward of a first outer end portion of the first roller in the width direction with respect to a conveyance center,
and configured to rotate following the document conveyed by the first roller.
